(19) United States
(12) Patent Application Publication
(10) Pub. No.: US 2022/0040782 A1
(43) Pub. Date: Feb. 10, 2022

(54) METHODS AND SYSTEMS FOR CLADDING

(71) Applicant: Paul Po Cheng, London (CA)

(72) Inventor: Paul Po Cheng, London (CA)

(21) Appl. No.: 16/984,446

(22) Filed: Aug. 4, 2020

(51) Int. Cl. B23K 20/00; B32B 15/01; C21D 8/00

(52) U.S. Cl. CPC B23K 20/00; B23K 2103/04; C21D 8/00; B32B 15/011

(57) ABSTRACT

A method of attaching a cladding element to a base element. A first inner side of the cladding element is positioned spaced apart from a second inner side of the base element to define a slot therebetween, and one or more heating elements are located in the slot. A non-oxidizing atmosphere is provided in the slot, and the heating element is energized, to heat at least portions of the cladding element and the base element to a hot working temperature. While at the hot working temperature, the first and second inner sides are engaged with each other, and one or both are moved relative to the other, for plastic deformation of the first and second inner sides, to subject the portions of the cladding element and the base element to shear stresses. The portions are allowed to cool, for recrystallization thereof.

### FIELD OF THE INVENTION

This invention is a method and a system for attaching cladding elements to base elements.

### BACKGROUND OF THE INVENTION

In the prior art, a layer of a suitable cladding material may be secured to an underlying base material, to provide, e.g., a layer of protective material inside a vessel or pipe, in which corrosive or abrasive materials (including, e.g., gases, liquids, or solids, or mixtures thereof) are receivable. Typically, the layer of the cladding material is relatively thin, and the base is thicker.

There may be various reasons for providing a layer of cladding material on the base. This arrangement is typically used because, in general, it is more economic than constructing the entire vessel or pipe from the cladding material. The cladding material is usually relatively expensive. The base layer may be, for example, a suitable steel, while the cladding layer typically is a more expensive material, selected for its abrasion- or corrosion-resistant qualities.

However, in the prior art, there are some disadvantages. In particular, where the cladding material has been welded to the base layer using conventional methods, the cladding material and the base layer may be adversely affected by “heat affected zones” that result from conventional methods.

### SUMMARY OF THE INVENTION

For the foregoing reasons, there is a need for a method and a system for attaching cladding elements to base elements that overcomes or mitigates one or more of the disadvantages or defects of the prior art. Such disadvantages or defects are not necessarily included in those described above.

In its broad aspect, the invention provides a method of attaching one or more cladding elements to a base element. The cladding element is spaced apart from the base element to locate a first inner side of the cladding element facing a second inner side of the base element, to define a slot therebetween. One or more heating elements are located in the slot, and a non-oxidizing atmosphere is provided in the slot, covering the first and second inner sides.

Next, the one or more heating elements are energized, to heat the first and second inner sides to a hot working temperature. Heated first and second layers of the cladding element and the base element respectively are provided at the first and second inner sides. The heating elements are removed from the slot, and while the first and second layers are at the hot working temperature, the first and second inner sides are engaged with each other. While the first and second inner sides are engaged with each other, at least part of the first and second inner sides is moved relative to the other of the first and second inner sides, to at least partially plastically deform the first and second layers, to subject the first and second layers to shear stresses. The first and second layers are then permitted to cool to a predetermined temperature, for recrystallization of the first and second layers, that are thereby bonded to each other.

### BRIEF DESCRIPTION OF THE DRAWINGS

The invention will be better understood with reference to the attached drawings, in which:

FIG. 1A is a schematic exploded plan view of an embodiment of the cladding element of the invention, a heating element, and a base element;

FIG. 1B is a cross-section of the elements of FIG. 1A, drawn at a larger scale;

FIG. 1C is a cross-section of the cladding element and the base element engaged with each other, in which one or both of the cladding element and the base element are oscillating relative to the other;

FIG. 1D is a cross-section of the cladding element and the base element engaged with each other, in which one or both of the cladding element and the base element is subjected to selective percussive engagement;

FIG. 2A is a an exploded cross-section of an alternative embodiment of the cladding element of the invention;

FIG. 2B is a cross-section of the cladding element of FIG. 2A and the base element, with one or more heating elements positioned between the cladding element and the base element;

FIG. 2C is a cross-section of the cladding element and the base element of FIG. 2B engaged with each other, in which one or both of the cladding element and the base element are oscillating relative to the other;

FIG. 2D is a cross-section of the cladding element and the base element of FIG. 2B engaged with each other, in which one or both of the cladding element and the base element is subjected to selective percussive engagement;

FIG. 3A is an exploded cross-section in which an embodiment of the cladding element of the invention has a cladding element serrated face and an embodiment of the base element of the invention has serrated face, and a heating element is positioned between the cladding element and the base element;

FIG. 3B is an exploded cross-section in which the base element has a base element serrated face, and a heating element is positioned between the cladding element and the base element;

FIG. 3C is an exploded cross-section in which an embodiment of the cladding element has a cladding element serrated face, and a heating element is positioned between the cladding element and the base element;

FIG. 4A is a plan view of another embodiment of two cladding elements of the invention, each of which includes a thick region at an edge of the cladding element;

FIG. 4B is a cross-section of the cladding elements of FIG. 4A;

FIG. 4C is a cross-section of the cladding elements of FIGS. 4A and 4B secured to a base element, defining an opening in a boundary region between the cladding elements, with a heating element positioned proximal to the boundary region, for heating the thick regions;

FIG. 4D is a cross-section of the cladding elements and the base element of FIG. 4C in which the thick regions are engaged by forming devices, to urge at least part of the thick portions into the opening;

FIG. 4E is a plan view of two cladding elements spaced apart to define an opening therebetween, drawn at a larger scale;

FIG. 4F is a cross-section of one of the cladding elements of FIG. 4E and a forming device positioned thereon;

FIG. 4G is a cross-section of the cladding elements and the base element of FIG. 4D in which a first one of the thick regions is urged into the opening, drawn at a smaller scale;

FIG. 4H is a cross-section of the cladding elements and the base element of FIG. 4E in which a second one of the thick regions is urged over the first one of the thick regions;

FIG. 4I is a cross-section of the first and second thick regions of FIG. 4F in the opening in which an additional cladding element is positioned thereon;

FIG. 4J is a cross-section of alternative embodiments of the cladding elements of the invention positioned adjacent to each other to define the opening therebetween in which the thick regions are of unequal sizes;

FIG. 4K is a cross-section of another embodiment of the cladding element of the invention showing a profile of the thick region thereof, drawn at a larger scale;

FIG. 4L is a cross-section of an alternative embodiment of the cladding element of the invention showing an alternative profile of the thick region thereof;

FIG. 4M is a cross-section of two cladding elements secured to a base element, each of the cladding elements including a thick region, drawn at a smaller scale;

FIG. 5A is a cross-section of a portion of a vessel including a base element and including a tube portion to permit fluid to exit from a chamber of the vessel, in which inner and outer cladding elements are positioned to be heated, to be secured to the base element and overlap with each other, drawn at a smaller scale;

FIG. 5B is a cross-section of the vessel of FIG. 5A in which the outer cladding element is urged against the base element in the body portion and against the inner cladding element in the tube portion;

FIG. 5C is a cross-section of a portion of a vessel including a base element and including a tube portion to permit fluid to enter into the vessel, in which inner and outer cladding elements are positioned to be heated, to be secured to the base element and overlap with each other;

FIG. 5D is a cross-section of the vessel of FIG. 5C in which the outer cladding element is urged against the inner cladding element in the body portion and against the base element in the tube portion;

FIG. 5E is a cross-section of a portion of a vessel including a base element and having a tube portion to permit fluid to exit from a chamber of the vessel, in which inner cladding elements are secured to the base element in the tube portion and the body portion, and an outer cladding element is positioned to cover preselected parts of the inner cladding elements;

FIG. 5F is a cross-section of the vessel of FIG. 5E in which a forming device is positioned for urging the outer cladding element against the inner cladding elements;

FIG. 6 is a cross-section of two cladding elements with thick portions at edges thereof, with an overlapping cladding element, positioned on a curved exterior surface of a vessel or pipe made of a base element;

FIG. 7 is a cross-section of two cladding elements with thick portions, with an overlapping cladding element, positioned on an exterior surface of a vessel or pipe made of a base element;

FIG. 8A is a cross-section of a cladding element secured to a base element, the cladding element including an opening therein;

FIG. 8B is a cross-section of an embodiment of a patch cladding element of the invention located in the opening in the cladding element of FIG. 8A, the patch cladding element including a central region having a central region thickness and an outer region with an outer region thickness greater than the central region thickness, the patch cladding element in the opening defining a trough between the cladding element and the patch cladding element;

FIG. 8C is a cross-section of the patch cladding element and cladding element of FIG. 8B in which the outer regions have been at least partially pushed into the trough;

FIG. 8D is a cross-section of the patch element and the cladding element of FIG. 8B in which an additional cladding element is secured to the patch cladding element and the cladding element, to at least partially cover each of the patch cladding element and the cladding element;

FIG. 8E is a plan view of the additional cladding element positioned on each of the patch cladding element and the cladding element of FIG. 8C;

FIG. 9A is a plan view of a body portion of a vessel including an opening, the body portion being made of a base element, drawn at a larger scale;

FIG. 9B is a cross-section of a portion of the vessel of FIG. 9A, with a cladding element spaced apart from the base element to define a slot, in which a heating element is positioned;

FIG. 9C is a plan view of the cladding element engaged with the base element;

FIG. 9D is a cross-section of the cladding element and the base element of FIG. 9C;

FIG. 10A is a cross-section of two pipes that are joined together at their ends, the pipes defining a boundary region therebetween including an opening therein, in which cladding elements are located proximal to the boundary region, drawn at a smaller scale;

FIG. 10B is a cross-section of the pipes of FIG. 10A in which forming devices are located for engagement with the cladding elements;

FIG. 10C is a cross-section showing the cladding elements of FIG. 10B, formed to cover the boundary region between the two pipes;

FIG. 11A is a cross-section of a base element with cladding elements secured thereto and defining an opening therebetween, drawn at a smaller scale;

FIG. 11B is a cross-section of the base element and cladding elements of FIG. 11A with an additional cladding element positioned proximal to the opening and spaced apart from the cladding elements to define a slot between the additional cladding element and the cladding elements, with a heating element positioned in the slot;

FIG. 11C is a cross-section of the base element and cladding elements of FIG. 11B in which the additional cladding element is at least partially urged into the opening; and

FIG. 11D is a cross-section of the base element and cladding elements of FIGS. 11A-11C in which the additional cladding element is located in the opening.

### DETAILED DESCRIPTION

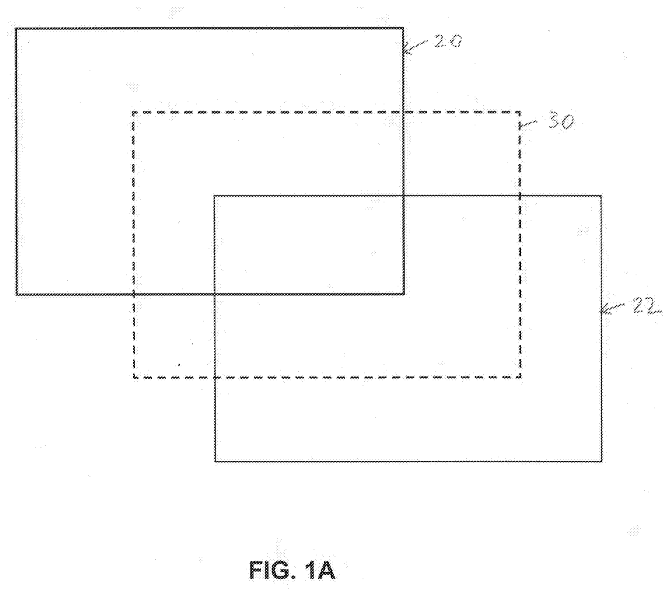

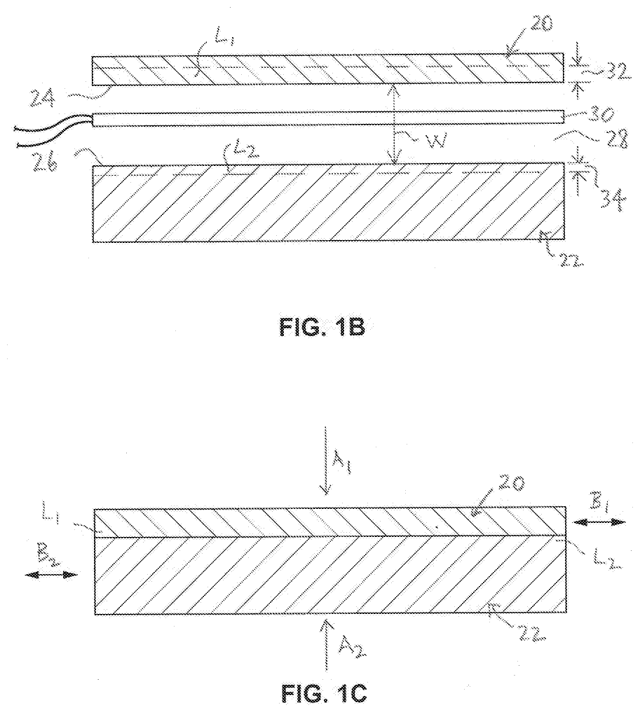

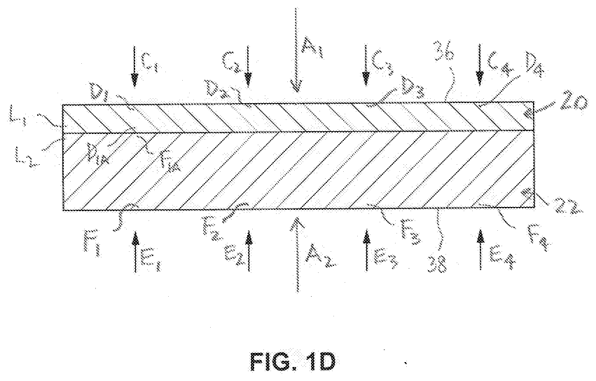

In the attached drawings, like reference numerals designate corresponding elements throughout. Reference is first made to FIGS. 1A-1D to describe an embodiment of a method in accordance with the invention.

In one embodiment, the method is for attaching one or more cladding elements 20 at least partially made of a first metal to a base element 22 that is at least partially made of a second metal. Preferably, the method includes positioning the cladding element 20 spaced apart from the base element 22 to locate a first inner side 24 of the cladding element 20 facing a second inner side 26 of the base element 22, for defining a slot 28 therebetween having a predetermined width “W”. As illustrated, one heating element 30 is located in the slot 28. However, it will be understood that a number of heating elements may be utilized.

It is also preferred that a non-oxidizing atmosphere is provided in the slot 28. The non-oxidizing atmosphere covers the first and second inner sides 24, 26.

Next, the heating element 30 is energized, to heat the first inner side 24 and the second inner side 26 to a hot working temperature of the first metal and the second metal. Preferably, the heating element 30 is configured to distribute heat energy therefrom evenly over each of the first and second inner sides 24, 26, heating the cladding element 20 and the base element 22 to predetermined first and second depths 32, 34 (FIG. 1B) relative to the first and second inner sides 24, 26 respectively, to provide first and second layers “L₁”, “L₂” of the cladding element 20 and the base element 22 respectively that are heated to the hot working temperature.

The heating element 30 is then removed from the slot 28.

While the first and second layers “L₁”, “L₂” are at the hot working temperature, the first and second inner sides 24, 26 are engaged with each other. It is also preferred that, while the first and second inner sides 24, 26 are engaged with each other, at least part of one of the cladding element 20 and the base element 22 is moved relative to the other of the cladding element 20 and the base element 22, to at least partially plastically deform the first and second layers “L₁”, “L₂” to subject the first and second heated layers to shear stresses. As will be described, it is believed that at least partial plastic deformation of the first and second layers “L₁”, “L₂” is for at least partial uniformity of the microstructures of the first and second layers “L₁”, “L₂”.

Preferably, the first and second heated layers “L₁”, “L₂” are permitted to cool to a predetermined temperature, for recrystallization of the first and second layers “L₁”, “L₂”, that are thereby bonded to each other. Those skilled in the art would be aware of a temperature at which recrystallization may take place.

The process whereby two metal elements may be bonded to each other after they have been heated to a hot working temperature was described in U.S. Pat. No. 9,644,769, which patent is hereby incorporated herein by reference.

As is known in the art, conventional welding techniques typically result in positioning weld material that is melted and positioned in or on an article, to form a welded workpiece. The weld material is allowed to cool. A part of the article is affected by the heat from the weld material, and such part is referred to as a “heat-affected zone” (HAZ). The size of the HAZ in the article varies depending on a number of factors. The HAZ has undesirable characteristics, which may, among other things, be subject to corrosion.

The undesirable characteristics of the HAZ are believed to be at least partially due to the completed welded workpiece including different grain sizes in its microstructures. The different grain sizes (e.g., varying throughout the HAZ) are due to the different thermal treatments to which the HAZ is subjected, at different locations therein, and also the grain sizes of the welded metal are also different from those in the HAZ. It is believed that, due to different grain sizes in the welded workpiece (and in particular, in the HAZ), the welded workpiece is subject to internal residual stresses.

In contrast, in one embodiment of the method of the invention herein, the metals to be bonded together (e.g., in the layers “L₁” and “L₂”) are believed to include substantially uniform grain sizes, once they are bonded together. As described above, the layers “L₁”, “L₂” are heated to a hot working temperature, at least to the first and second depths 32, 34 thereof respectively, and while at the hot working temperature, the layers “L₁”, “L₂” are engaged with each other so as to subject the layers (at least to the first and second depths thereof) to shear stresses. This may be done, as described below, by oscillating movement of one layer relative to the other, as the layers “L₁”, “L₂” are engaged with each other, while pressed against each other.

Although the process is not well understood at this time, it is believed that subjecting the layers “L₁”, “L₂” to at least the respective depths 32, 34 thereof respectively to shear stresses deforms the microstructures of the layers “L”, “L” (at least to the respective depths 32, 34 thereof), to form substantially uniform grains in those microstructures, with substantially uniform grain sizes. It is also believed that this shaping of the grain sizes in the microstructures begins to take place as the layers “L₁”, “L₂” are bonded together, initially at the hot working temperature, due to plastic deformation upon engagement of the layers “L₁”, “L₂” with each other. As the layers “L₁”, “L₂” are cooled from the hot working temperature to room or ambient temperature, recrystallization takes place, forming the substantially uniform grains in the microstructures (i.e., for at least partial uniformity of the microstructures) of the bonded layers “L₁”, “L₂”.

Those skilled in the art would appreciate that, in general, the cladding element is much thinner than the base element.

The predetermined width of the slot preferably is sufficient to receive the heating element(s) and to locate the heating element(s) relative to each of the first and second inner sides so that the first and second layers will both be heated to the hot working temperature. Those skilled in the art would appreciate that the heating element(s) may not necessarily be positioned equidistant from each of the first and second inner sides, in order to heat both the first and second layers to the hot working temperature.

It will be understood that, to engage the first and second inner sides 24, 26, one or both of the cladding element 20 and the base element 22 preferably are moved in one or both of preselected directions that are orthogonal to the first and second inner sides 24, 26. The preselected directions are indicated by arrows “A₁”, “A₂” in FIGS. 1C and 1D.

It will also be understood that the movement of at least part of one or both of the cladding element 20 and the base element 22 relative to the other may be effected in any suitable manner, using any suitable means. For example, in one embodiment, the movement one of the cladding element 20 and the base element 22, or both, is transverse to the preselected orthogonal directions indicated by arrows “A₁”, “A₂”. The transverse movement of the cladding element 20 relative to the base element 22 is indicated by arrow “B₁” in FIG. 1C. Similarly, the transverse movement of the base element 22 relative to the cladding element 20 is indicated by arrow “B₂” in FIG. 1C. As noted above, in one embodiment, the cladding element 20 and the base element 22 may be moved relative to each other simultaneously.

Those skilled in the art would appreciate that oscillation of the cladding element 20 and/or the base element 22 relative to the other of the cladding element and the base element may not be feasible or practicable, in certain situations. Accordingly, in another embodiment, the movement of the part of the cladding element 20 and the base element 22 is effected by percussively engaging the part of one or both of the cladding element 20 and the base element 22 in a direction parallel (or substantially parallel) to the preselected orthogonal directions.

As can be seen in FIG. 1D, the percussive engagement with the cladding element 20 and/or the base element 22 may be directed against a first outer side 36 of the cladding element 20, and/or against a second outer side 38 of the base element 22. The percussive engagement with the first outer side 36 is schematically illustrated by arrows “C₁”-“C₄”. The parts of the cladding element 20 that are directly engaged by the percussive engagement against the first outer side 36 are identified by reference characters “D₁”-“D₄”. The percussive engagement with the second outer side 38 is schematically illustrated by arrows “E₁”-“E₄”, and the parts of the base element 22 that are directly engaged by the percussive engagement against the second outer side 38 are identified by reference characters “F₁”-“F₄”.

It will be understood that the percussive engagement may be effected by any suitable means. It is believed that the percussive engagement may be used to achieve some uniformity in the microstructures of the first and second layers “L₁”, “L₂”, or at least the parts thereof that are directly impacted by the percussive engagement.

For instance, the parts “D₁”-“D₄” of the layer “L₁” are directly impacted by percussive engagement schematically indicated by arrows “C₁”-“C₄” respectively (FIGS. 1B, 1D). As noted above, the percussive engagement may be with the first outer side 36 or with the second outer side 38, affecting different parts respectively, or with both simultaneously.

It is believed that a part “D_{1A}” of the first layer “L₁” that is engaged with a part “F_{1A}” of the second layer “L₂” will be plastically deformed upon percussive engagement at “C₁”. Also, the part “F_{1A}” will simultaneously be plastically deformed. Because the layers “L”, “L” are at the hot working temperature when the plastic deformation takes place, it is believed that the layers “L”, “L” will thereby be bonded with each other. However, it is believed that such bonding takes place only at the locations at the first and second layers that are engaged with the other layer and are generally aligned with the points (e.g., “C₁”-“C₄”, and/or “E₁”-“E₄”) where the percussive engagement is effected.

It is also believed that recrystallization takes place as the cladding element and the base element are cooled to ambient (or room) temperature, and uniformity of the microstructures in the locations at the first and second layers that are engaged with the other layer and are generally aligned with the points (e.g., “C₁”-“C₄”, and/or “E₁”-“E₄”) where the percussive engagement is effected.

The width “W” of the slot may be any suitable width. The heating element(s) may be positioned in the slot in any suitable location. For example, if the base element is expected to take longer to heat up to the hot working temperature (e.g., due to the metal's characteristics, or because the mass of the base element is substantially larger than the mass of the cladding element), then the heating element may be positioned closer to the base element than to the cladding element. Alternatively, it may be advantageous to position the heating element closer to the cladding element than to the base element.

It will also be understood that, instead of percussive engagement, in another embodiment, the cladding element 20 and the base element 22 may be bonded together upon the application of suitable pressure, while the first and second layers “L₁” and “L₂” are at the hot working temperature.

In this embodiment, while the first and second inner sides 24, 26 are engaged with each other, at least part of one of the cladding element 20 and the base element 22 is pressed against the other of the cladding element 20 and the base element 22, or the cladding element 20 and the base element 22 are simultaneously pressed together, to plastically deform the first and second layers to subject the layers “L₁”, “L₂” to shear stresses, to provide at least partial uniformity of the microstructures of the first and second layers.

For example, the pressure may be exerted against the first outer side 36 as indicated by arrows “C₁”-“C₄” in FIG. 1D, and the base element 22 may be supported on its second outer side 38 in the direction opposite. Alternatively, the pressure may be exerted against the second outer side 38 as indicated by arrows “E₁”-“E₄” in FIG. 1D, and the cladding element 20 may be supported on its first outer side 36 in the direction opposite. The pressure may be exerted against the first and second outer sides 36, 38 simultaneously, in opposite directions.

The pressure may be exerted at points on the first and/or second outer sides 36, 38 as indicated in FIG. 1D, or instead the pressure may be exerted against the entire first or second outer side 36, 38, as the case may be. It is believed that there may be sufficient plastic deformation at the locations (e.g., “D_{1A}”, “F_{1A}”) where the cladding element and the base element are engaged with each other and aligned with the points (e.g., “C₁”, “E₁”) where the percussive engagement takes place.

Preferably, the first and second layers “L₁”, “L₂” are permitted to cool to a predetermined temperature, for recrystallization of the first and second metals in the respective first and second layers “L₁”, “L₂”, that are thereby bonded to each other. The predetermined temperature may be any suitable temperature, which those skilled in the art would be aware of. For example, the predetermined temperature may be a room temperature, or an ambient temperature.

It will be understood that any suitable method of engaging the materials that are at the hot working temperature, and subjecting them to shear stresses, may be utilized for bonding them together.

In one embodiment, it is preferred that either, or both, of the first inner side 24 and the second inner side 26 is scored, for engagement of the first and second inner sides 24, 26 with each other. It will be understood that, for the purposes hereof, “scored” refers to any roughened surface, whether the surface includes serrations, or irregular scratches or bumps. The first inner side, or the second inner side, or both, may be scored. The scoring on the roughed surface may include smaller or larger ridges, and the ridges may be random, or made in a pattern.

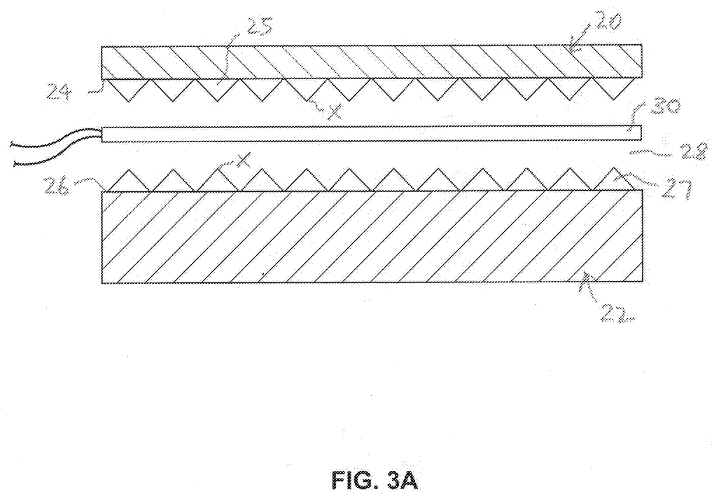

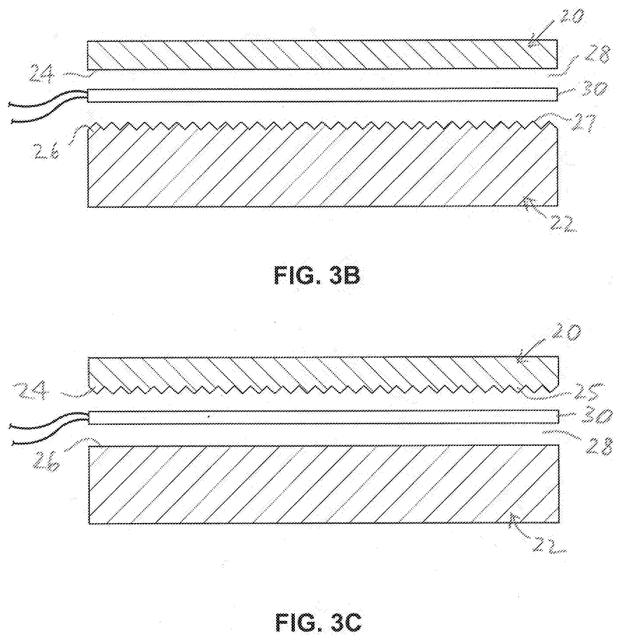

For example, as illustrated in FIG. 3A, both the first inner side and the second inner side may be scored. The scored portions of the first and second inner sides 24, 26 are identified by reference numerals 25, 27 respectively in FIG. 3A. It will also be understood that the serrations on the first and second inner sides are exaggerated for the purposes of illustration.

It is believed that the temperature of tips “X” of the scored surfaces may be raised more quickly than the temperature of the body of the cladding element and/or the base element, because the tips “X” each have relatively small cross-sections, and also because of their proximity to the heating element.

Those skilled in the art would appreciate that, as a practical matter, heating the first and second inner sides of the cladding element and the base element to the hot working temperature may not be feasible, in some circumstances. For example, when the cladding element and the base element are made of a first metal and a second metal respectively, depending on the metals, there may not be a hot working temperature that is suitable for both the first and second metal. Alternatively, it may be preferred that the cladding element is a ceramic material, or glass, or any other suitable abrasion- or corrosion-resistant material.

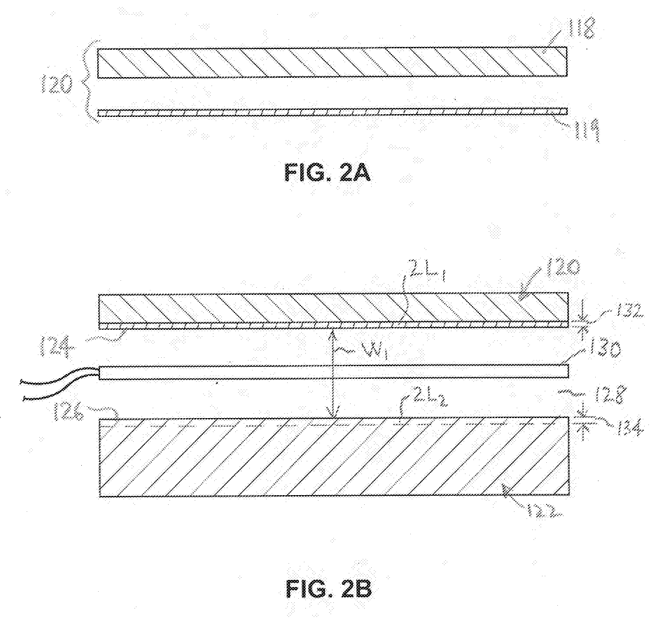

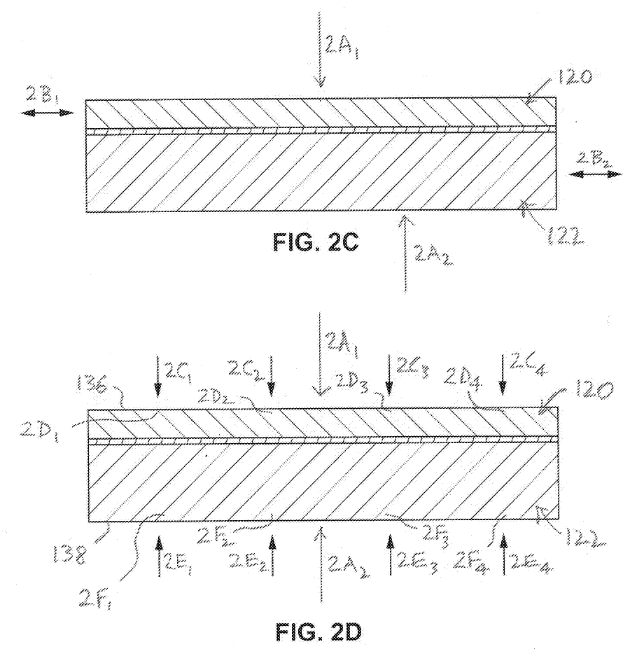

In order to address these issues, in one embodiment, the method of the invention includes, first, securing a cladding element 118 with a first metal element 119 to form one or more cladding assemblies 120 (FIG. 2A). The cladding element 118 may be any suitable abrasion- or corrosion-resistant material, e.g., ceramic or glass or metal. The cladding element 118 may include, for example, layers of ceramic material baked to form a suitable cladding, before being secured to the first metal element 119. The first metal element 119 preferably is a metal that may be bonded with a base element 122 made of a second metal element (e.g., steel), as will be described. It will be understood that the cladding element 118 and the first metal element 119 may be secured together by any suitable means, e.g., a suitable adhesive.

Preferably, the cladding assembly 120 is spaced apart from the base element 122 to locate a first inner side 124 thereof facing a second inner side 126 of the base element 122, for defining a slot 128 therebetween having a predetermined width “W₁” (FIG. 2B).

Next, one or more heating elements 130 are located in the slot 128.

Preferably, a non-oxidizing atmosphere is provided in the slot 128. The non-oxidizing atmosphere preferably covers the first and second inner sides 124, 126.

The heating element 130 is energized, to heat the first inner side 124 and the second inner side 126 to a hot working temperature of the first and second metals. It is preferred that the heating element 130 is configured to distribute heat energy therefrom evenly over each of the first and second inner sides 124, 126, heating the first metal element 119 and the base element 122 to predetermined first and second depths 132, 134 relative to the first and second inner sides 124, 126 respectively, to provide first and second layers “2L₁”, “2L₂” of the first metal element 119 and the base element 122 respectively.

The heating element 130 is removed from the slot 128.

While the first and second layers “2L₁”, “2L₂” are at the hot working temperature, the first and second inner sides 124, 126 are engaged with each other.

While the first and second inner sides 124, 126 are engaged with each other, at least part of one of the first metal element 119 and the base element 122 is moved relative to the other of the first metal element 119 and the base element 122, to at least partially plastically deform the first and second layers to subject the first and second layers to shear stresses, to at least partially align microstructures of the first and second layers. The first and second layers “2L₁”, “2L₂” are permitted to cool to a predetermined temperature, for recrystallization of the first and second metals in the respective first and second layers “2L₁”, “2L₂”, that are thereby bonded with each other.

As can be seen in FIGS. 2C and 2D, in order to engage the first and second inner sides 124, 126, one or both of the cladding assembly 120 and the base element 122 preferably are moved in one or both of preselected directions that are orthogonal to the first and second inner sides 124, 126. The preselected directions are indicated by arrows “2A₁”, “2A₂” in FIGS. 2C and 2D.

As described above, the movement of at least part of the first metal element 119 and/or the base element 122 relative to the other of the first metal element 119 and the base element 122 may be effected in any suitable manner. For example, as illustrated in FIG. 2C, in one embodiment, the movement of part of one of the cladding assembly 120 and the base element 122, or both, is transverse to the orthogonal directions indicated by arrows “2A₁”, “2A₂”. The transverse movement of the cladding assembly 120 relative to the base element 122 is indicated by arrow “2B₁” in FIG. 2C. Similarly, the transverse movement of the base element 122 relative to the cladding assembly 120 is indicated by arrow “2B₂” in FIG. 2C. As noted above, in one embodiment, the cladding assembly 120 and the base element 122 may be moved relative to each other simultaneously.

Those skilled in the art would appreciate that oscillation of the cladding assembly 120 and/or the base element 122 relative to the other of the cladding assembly 120 and the base element 122 may not be feasible or practicable, in certain situations. Accordingly, in another embodiment, the movement of the part of the cladding assembly 120 and the base element 122 preferably is effected by percussively engaging the part of one or both of the cladding assembly 120 and the base element 122 in a direction parallel to the preselected orthogonal directions.

As can be seen in FIG. 2D, the percussive engagement with the cladding assembly 120 and/or the base element 122 may be directed against a first outer side 136 of the cladding assembly 120, and/or against a second outer side 138 of the base element 122. The percussive engagement with the first outer side 136 is schematically illustrated by arrows “2C₁”-“2C₄”. The parts of the cladding assembly 120 that are directly engaged by the percussive engagement against the first outer side 136 are identified by reference characters “2D₁”-“2D₄”. The percussive engagement with the second outer side 138 is schematically illustrated by arrows “2E₁”-“2E₄”, and the parts of the base element 122 that are directly engaged by the percussive engagement against the second outer side 138 are identified by reference characters “2F₁”-“2F₄”. The percussive engagement may be with the first outer side 136 or the second outer side 138, or with both simultaneously.

It will be understood that, in one embodiment, one or both of the first inner side 124 and the second inner side 126 preferably is scored, for engagement of the first and second inner sides 124, 126 with each other.

It will also be understood that, instead of percussive engagement, in another embodiment, the cladding assembly 120 and the base element 122 may be bonded together upon the application of suitable pressure, while the first and second layers “2L₁” and “2L₂” are at the hot working temperature.

In this embodiment, while the first and second inner sides 124, 126 are engaged with each other, at least part of one of the first metal element 119 and the base element 122 is against the other of the first metal element 119 and the base element 122, or the first metal element 119 and the base element 122 are simultaneously pressed together, to plastically deform the first and second layers to subject the layers “2L₁”, “2L₂” to shear stresses, to provide at least partial uniformity of the microstructures of the first and second layers as described above.

For example, the pressure may be exerted against the first outer side 136 as indicated by arrows “2C₁”-“2C₄” in FIG. 2D, and the base element 122 may be supported on its second outer side 138 in the direction opposite. Alternatively, the pressure may be exerted against the second outer side 138 as indicated by arrows “2E₁”-“2E₄” in FIG. 2D, and the cladding assembly 120 may be supported on its first outer side 136 in the direction opposite. The pressure may be exerted against the first and second outer sides 136, 138 simultaneously, in opposite directions.

The pressure may be exerted at points on the first and/or second outer sides 136, 138 as indicated in FIG. 2D, or instead the pressure may be exerted against the entire first or second outer sides 136, 138, as the case may be.

It will be understood that any suitable method of engaging the materials that are at the hot working temperature, and subjecting them to shear stresses, may be utilized for bonding them together.

As described above, it is preferred that one or more of the first inner side 24 of the cladding element and the second inner side 26 of the base element is scored, for engagement of the first and second inner sides 24, 26 with each other. The slot 28 is defined between the first and second inner sides 24, 26.

For instance, in FIG. 3B, only the second inner side 26 is scored, with scorings or serrations 27. In FIG. 3C, only the first inner side is scored, with scorings or serrations 25.

As described above, once the first and second inner sides 24, 26 have been heated to the hot working temperature, the heating element 30 is removed from the slot 28. The first and second inner sides 24, 26 are then engaged with each other, and the cladding element and/or the base element (or parts thereof) are moved relative to the other, while engaged. Such movement is to plastically deform the cladding element and the base element at the first and second inner sides, for bonding them together, as described above.

Those skilled in the art would appreciate that, in certain applications, more than one cladding element may be required, e.g., in order to cover a relatively long base element. In these circumstances, there may be a relatively small crack or opening between two abutting cladding elements, and for abrasion or corrosion protection, it may be necessary to cover the crack or opening.

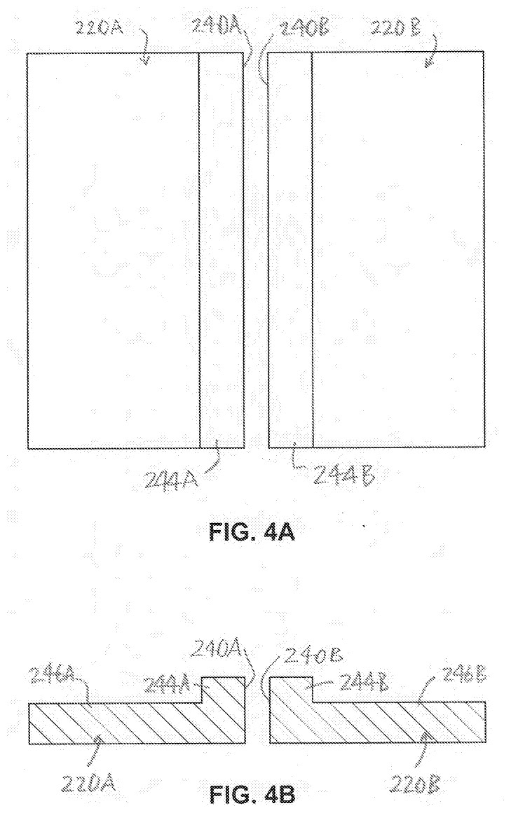

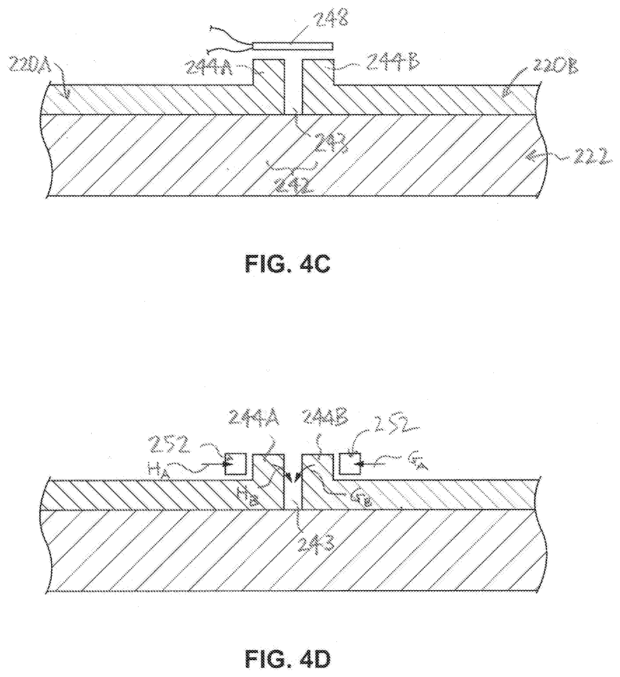

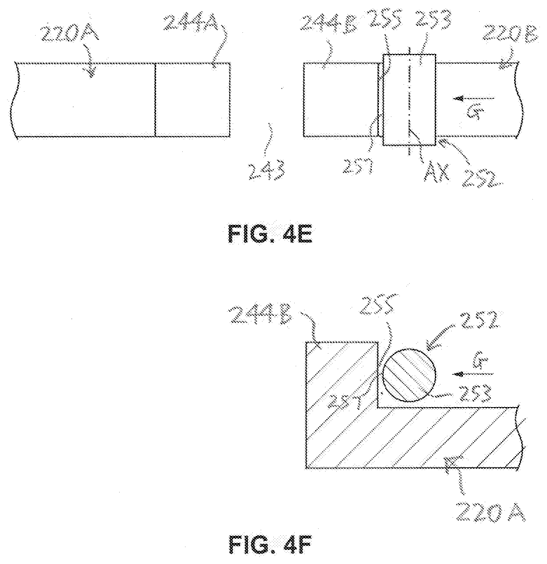

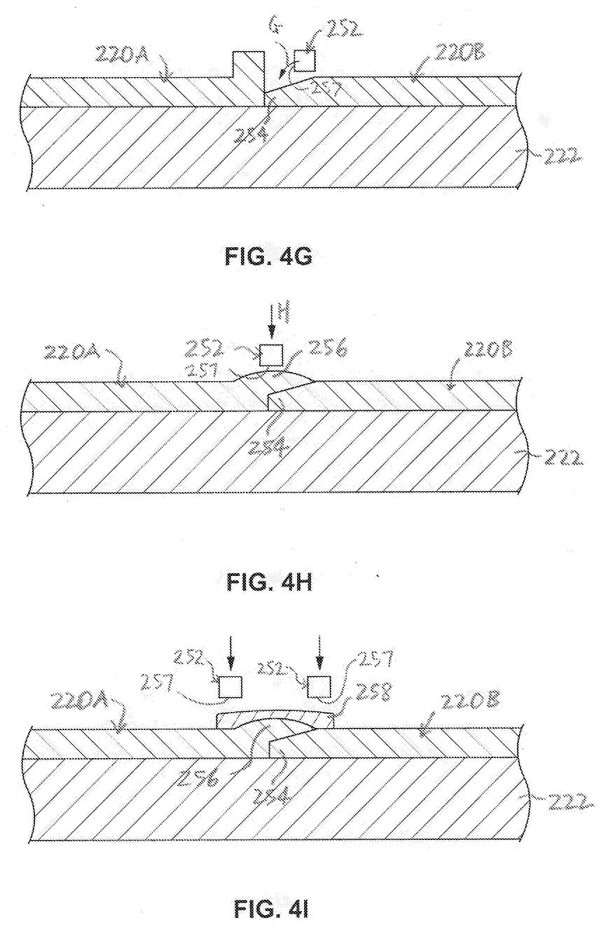

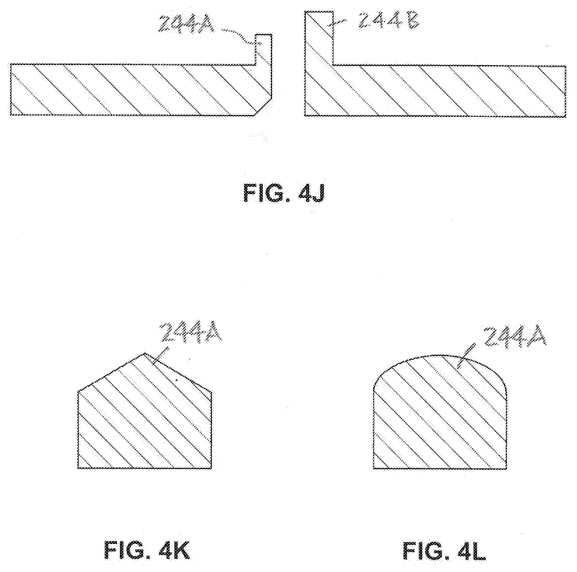

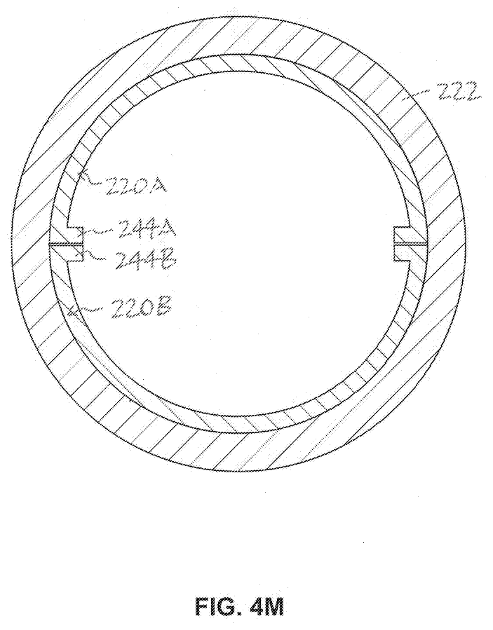

In one embodiment of the method of the invention, a first cladding element 220A and a second cladding element 220B each have edges 240A, 240B respectively, which are located proximal to each other after the first and second cladding elements 220A, 220B are attached to a base element 222 (FIG. 4C). It will be understood that the first and second cladding elements 220A, 220B are secured to the base element 222 in any suitable manner, e.g., as described above.

As can be seen in FIGS. 4C and 4D, the edges 240A, 240B define a boundary region 242 therebetween. An opening 243 is shown in FIGS. 4A-4D in the boundary region 242, between the edges 240A, 240B. It will be understood that, in FIGS. 4A-4D, the opening 243 between the two edges 240A and 240B as illustrated is disproportionately large, for clarity of illustration.

Preferably, each of the first and second cladding elements 220A, 220B includes a respective thick region 244A, 244B, extending along the edges 240A, 240B thereof respectively. As can also be seen, e.g., in FIG. 4B, it is preferred that each of the thick regions 244A, 244B is thicker than a balance 246A, 246B of the respective first and second cladding elements 220A, 220B. As will be described, it is preferred that the thick regions 244A, 244B include sufficient metal to fill, or substantially fill, the opening 243.

One or more supplemental heating elements 248 preferably is positioned proximal to the thick regions 244A, 244B of the first and second cladding elements 220A, 220B (FIG. 4C). As can be seen in FIG. 4C, it is preferred that the supplemental heating element 248 is spaced apart from the thick regions 244A, 244B by a predetermined distance 249.

Preferably, a non-oxidizing atmosphere is provided, so that when the supplemental heating element 248 is energized, the thick regions 244A, 244B are heated to a thick region hot working temperature. Next, with one or more forming devices 252, the thick regions 244A, 244B preferably are plastically deformed, to fill the opening 243.

As will be described, it is preferred that, with the forming devices 252, one thick region is pushed into the opening 243 before the other. For example, as indicated in FIG. 4D, the thick region 244B is pushed by the forming device 252 in the directions indicated by arrows “G_{A}”, “G_{B}”. As will be described, after the thick region 244B has been at least partly pushed into the opening 243, the first thick region 244A preferably is pushed onto the part of the second thick region 244B that was previously pushed into the opening. The first thick region 244A is pushed by the forming device 252 generally in the directions indicated by arrows “H_{A}”, “H_{B}” in FIG. 4D.

The forming devices 252 may be any suitable devices for engagement with the thick regions 244A, 244B after the thick regions 244A, 244B have been heated to the thick region hot working temperature. For example, in one embodiment, the forming devices 252 may include wheels or rollers 253 formed for engagement with the thick regions 244A, 244B, for generating more heat due to friction (FIGS. 4E, 4F). Preferably, the wheel 253 rotates about the axis “AX” thereof, at a sufficiently rapid speed so that, when the wheel 253 engages a surface 255 of the thick regions 244A, 244B, the surfaces 255 of the thick regions 244A, 244B are heated due to friction as a result. It will be understood that the forming device 252 has an engagement surface 257 for engaging the thick regions 244A, 244B, and where the forming device 252 includes the wheel 253, the engagement surface 257 is the surface of the wheel 253.

In one embodiment, it is preferred that the temperature of the thick regions 244A, 244B, is thereby maintained at the thick region hot working temperature, or substantially at the hot working temperature. Also, when the forming devices 252 engage the thick regions 244A, 244B, the rotating wheels 253 also push the thick regions 244A, 244B, into the opening 243, as will be described.

In an alternative embodiment, the forming device 252 does not include a wheel, but instead includes the engagement surface 257 that is adapted for engagement with the heated material, to push the heated material as desired, to fill the opening with at least part of the thick region 244B, and then to cover the part of the thick region 244B located in the opening 243.

It will be understood that the first cladding element 220A and the forming device to be engaged with the first cladding element 220A are omitted from FIG. 4F for clarity of illustration.

The engagement of the rotating wheel 253 with the thick region 244B is schematically illustrated in FIGS. 4E and 4F. In FIGS. 4E and 4F, for clarity of illustration, the wheel 253 is shown just before it engages the surface 255 of the thick region 244B. It will be understood that, once the wheel 253 engages the surface 255 of the thick region 253 to heat the thick region 244B due to friction, the wheel 253 also pushes against the surface 255 in the direction indicated by arrow “G”. Because the thick region 244B is at (or substantially at) its hot working temperature, the thick region 244B may be plastically deformed by the forming device 252.

As illustrated in FIGS. 4G and 4H, in one embodiment, the forming devices 252 preferably push a first portion 254 of the heated thick region 244B into the opening 243. Next, a second portion 256 of the heated thick region 244A is pushed onto the first portion 254 by one of the forming devices 252. In effect, the first portion 254 preferably is pushed into the opening 243, and the second portion 256 preferably is folded over the first portion 254.

Because it is anticipated that the cladding elements 220A, 220B will be engaged by abrasive and/or corrosive material, it is preferred that the cracks or small openings in the cladding elements or between the cladding elements be minimized. It is believed that the process of pushing first one portion 254 into the opening 243 and then folding the second portion 256 over the first portion 254 provides a configuration that is likely to wear well under abrasive or corrosive conditions.

Accordingly, those skilled in the art would appreciate that the first portion 254 preferably is pushed into the opening 243, to at least partially fill the opening 243, in the direction indicated by arrow “G” in FIG. 4G. As can be seen in FIG. 4H, the second portion 256 may be pushed in a generally opposite direction, and then pushed against the first portion 254 (as indicated by arrow “H”), to at least partially cover the first portion 254.

As can be seen, e.g., in FIGS. 4I, 6 and 7, in one embodiment, the boundary region 242 may be overlain by an additional cladding element 258 that is secured to the thick regions 244A, 244B. As shown in FIG. 4I, the additional cladding element 258 preferably is positioned over the first and second portions 254, 256 after the first portion 254 has been pushed into the opening 243, and the second portion 256 has been pushed onto or folded over the first portion 254. It will be understood that the additional cladding element 258 preferably is heated by a heating element (not shown) to its hot working temperature in a non-oxidizing atmosphere, and then pushed onto the first and second portions 254, 256 by forming devices 253′.

For example, as illustrated in FIG. 4I, the additional cladding element 258, once heated to its hot working temperature, is pushed downwardly (i.e., in the direction indicated by arrows “H₁”, “H₂” in FIG. 4I) to cover up any cracks or small openings between the first and second portions 254, 256.

It will be understood that the thick regions 244A, 244B may have a variety of configurations, and they may not be similar in their respective cross-sectional areas. As examples, various configurations of the thick regions are illustrated in FIGS. 4J-4L.

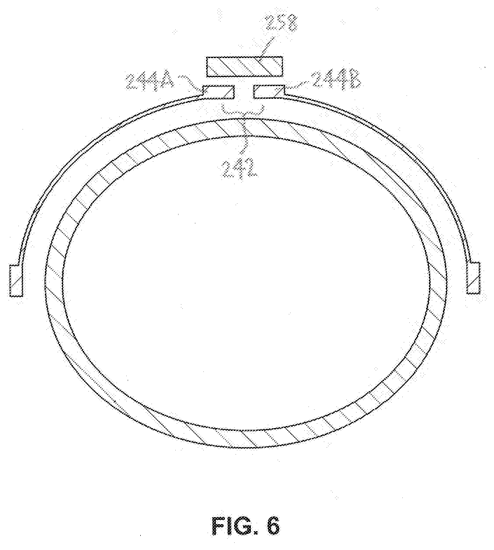

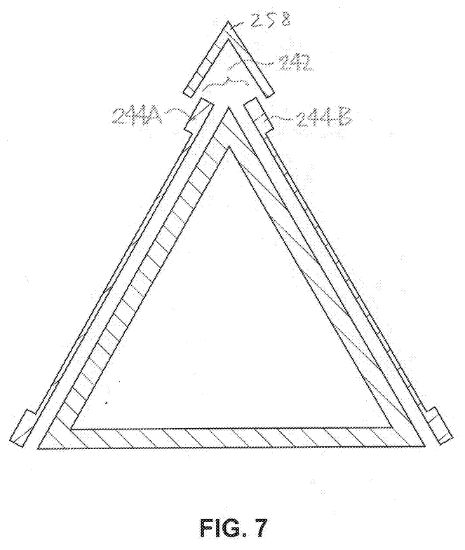

Also, although the cladding elements 220A, 220B are illustrated as being generally flat in FIGS. 4A-4J, it will be understood that the cladding elements may be formed to conform to the shape of the base element. For example, as shown in FIG. 4M, the base element 222 may be pipe or other vessel with a circular cross-section, and the cladding elements 220A, 220B may be formed to fit inside the pipe. Other examples are shown in FIGS. 6 and 7.

Those skilled in the art would appreciate that, where the cladding element includes ceramic material, the ceramic cladding material preferably does not include thick regions along the edges of the cladding elements. Instead, the opening between the cladding elements would be filled by a material that is bondable with the ceramic material, and will also bond with the base element, and will also be resistant to abrasion or corrosion.

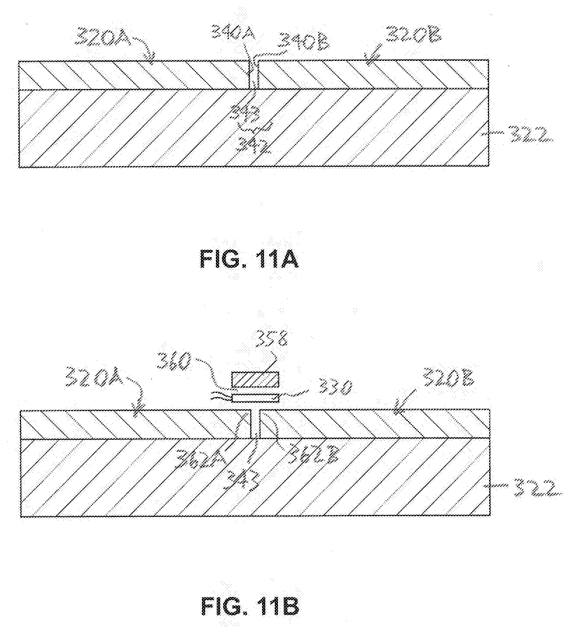

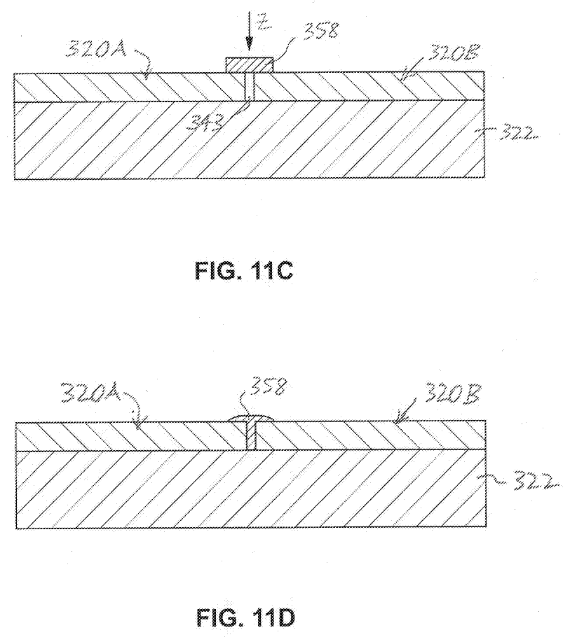

In another embodiment, illustrated in FIGS. 11A-11D, the method of the invention includes providing one or more additional cladding elements 358.

As shown in FIG. 11A, first and second cladding elements 320A, 320B are secured to the base element 322 to define the opening 343 therebetween, in the boundary region 342. It will be understood that the cladding elements preferably are previously secured to the base element, e.g., by utilizing one of the methods described above. As can be seen in FIG. 11B, the additional cladding element 358 preferably is located spaced apart from the first and second cladding elements 320A, 320B proximal to the edges 340A, 340B thereof to define an additional element gap 360 between the additional cladding element 358 and the first and second cladding elements 320A, 320B.

Next, one or more heating elements 330 is positioned in the additional element gap 360. The heating element 330 is energized in a non-oxidizing atmosphere, to heat the first and second cladding elements 320A, 320B and the additional cladding element 358 to a hot working temperature. It will be understood that only portions 362A, 362B of the first and second cladding elements 320A, 320B that are at the edges 340A, 340B or proximal thereto are heated to the hot working temperature.

While the additional cladding element 358 and the first and second cladding elements 320A, 320B are at the additional cladding element hot working temperature, engaging the additional cladding element 358 with the first and second cladding elements 320A, 320B at the edges 340A, 340B thereof, so that the additional cladding element 358 covers the boundary region 342 (FIG. 11C). The additional cladding element 358 preferably is moved as indicated by arrow “Z” in FIG. 11C, to engage the cladding elements 320A, 320B.

Preferably, while the additional cladding element 358 is engaged with the first and second cladding elements 320A, 320B, at least part of the additional cladding element 358 is moved relative to the first and second cladding elements 320A, 320B, to plastically deform the additional cladding element 358 and at least the portions 362A, 362B of the first and second cladding elements 320A, 320B, to at least partially align microstructures of the additional cladding element 358 and the first and second cladding elements 320A, 320B. It is preferred that the additional cladding element 358 fills (or substantially fills) the opening 343 (FIG. 11D).

The additional cladding element 358 and the first and second cladding elements 320A, 320B are permitted to cool to a predetermined temperature, for recrystallization of the additional cladding element 358 and the first and second cladding elements 320A, 320B, wherein the additional cladding element 358 is thereby bonded to the first and second cladding elements 320A, 320B, and the additional cladding element 358 fills the opening 343.

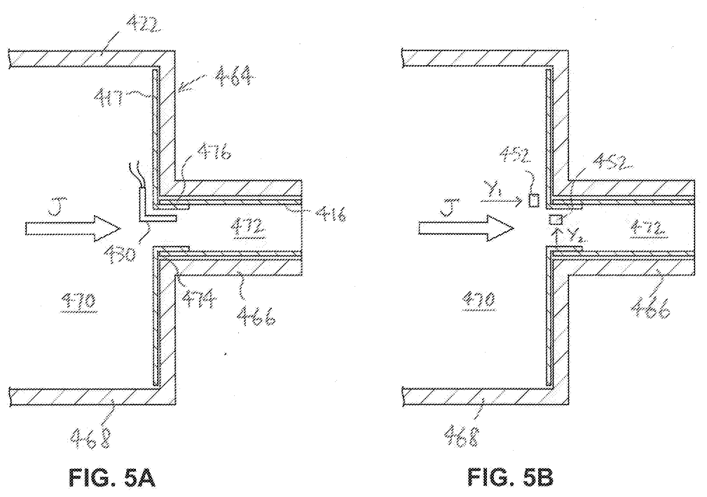

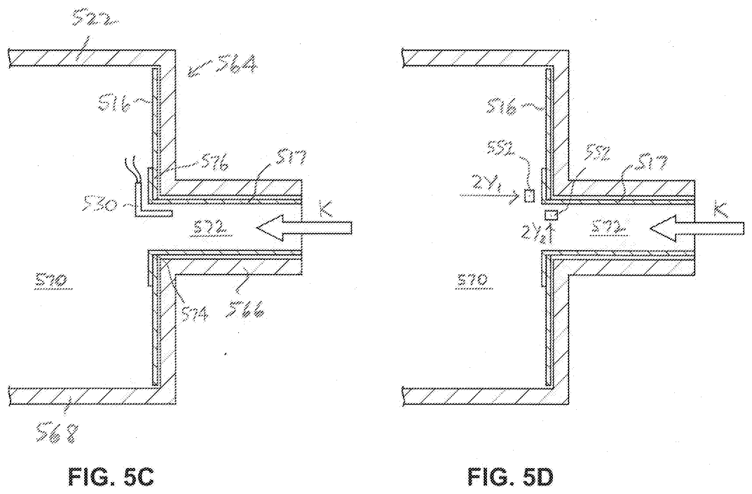

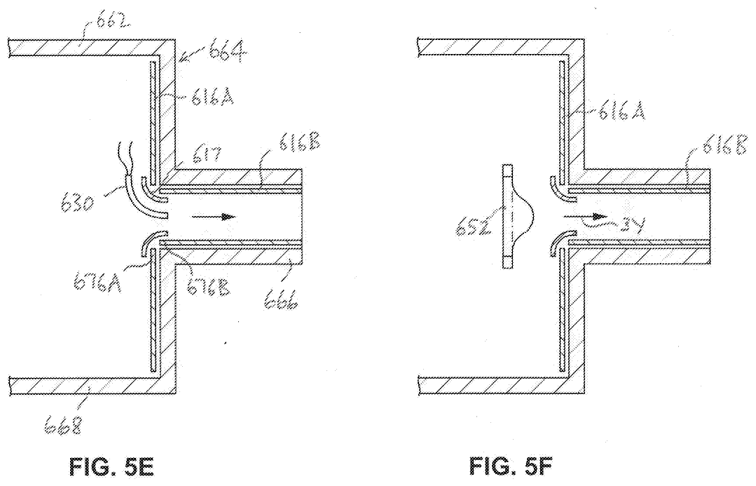

In another embodiment, the method of the invention is for covering a base element 422 that defines a vessel 464 including a tube portion 466 and a body portion 468 defining a chamber 470 therein. As can be seen in FIG. 5A, the tube portion 466 defines a channel 472 therein in fluid communication with the chamber 470, to permit flow through the tube portion 466 in a predetermined downstream direction, indicated by arrow “J” in FIGS. 5A and 5B. Preferably, the method includes providing inner and outer cladding elements 416, 417.

It is preferred that the inner cladding element 416 is secured to the base element 422 downstream relative to the predetermined downstream direction. The inner cladding element 416 preferably includes one or more edges 474 thereof positioned proximal to the channel 472. It will be understood that the inner cladding element 416 preferably is secured to the base element 422 after induction heating of the inner cladding element 416 and the base element 422 to a hot working temperature, and the inner cladding element 416 is then engaged with the base element 422, for bonding the inner cladding element 416 and the base element 422 together. The elements for securing the inner cladding element 416 to the base element 422 are omitted from the drawings, for clarity of illustration.

For example, and as can be seen in FIGS. 5A and 5B, the inner cladding element 416 is secured to the tube portion 466. It will be understood that the inner cladding element 416 may be secured to an inner surface of the tube portion, e.g., as described above. In FIGS. 5A and 5B, the flow of the liquid is from the chamber 470 into the channel 472, and therefore the tube portion 466 is downstream relative to the body portion 468.

As can be seen in FIG. 5A, the outer cladding element 417 preferably is positioned to cover the edge 474 and at least part 476 of the inner cladding element 416. One or more heating elements 430 are positioned proximal to the outer cladding element 417, for induction heating of the outer cladding element 417 in a non-oxidizing atmosphere to a hot working temperature. It will be understood that, for clarity of illustration, only one heating element 430 is shown in FIG. 5A.

Preferably, after the outer cladding element 417 is heated to a hot working temperature, the outer cladding element 417 is pressed against the part 476 of the inner cladding element 416 that the outer cladding element 417 overlaps, and the outer cladding element 417 is also engaged directly with the base element 422, in the body portion. The outer cladding element 417 preferably is pressed against the part 476 and the base element 422 by forming devices 452, (e.g., in the directions indicated by arrows “Y₁” and “Y₂” in FIG. 5B) so that the outer cladding element 417 is formed to cover the edge 474 and the part 476 of the inner cladding element 416.

It will be understood that any suitable devices may be utilized as the forming devices. In one embodiment, for example, the forming device may be a device intended to heat the heated material by friction, so that the metal may be maintained thereby at a hot working temperature, or a temperature that is close to the hot working temperature, and simultaneously pushing the heated material, and/or pressing on the heated material. Alternatively, the forming device may be utilized simply to form the heated material, by pushing it, and/or pressing on the heated material.

It will be understood that the positioning of the inner cladding element 416 and the outer cladding element 417 relative to the channel 472 may depend, in part, on the direction of flow through the channel 472. For example, in FIGS. 5C and 5D, the predetermined direction of flow is indicated by arrow “K”. The vessel 564 is made of a base element 522, and includes a body portion 568 and a tube portion 566. In FIGS. 5C and 5D, the direction of the flow is through the channel 572 and into the chamber 570. In this case, the inner cladding element 516 is secured to the body portion 568, defining the chamber 570.

As outer cladding element 517 preferably is positioned to cover an edge 574 of the inner cladding element 516 that is proximal to the channel 572, and also to cover a part 576 of the inner cladding element 516. The outer cladding element 517 preferably is also positioned to cover the tube portion's interior, which is upstream relative to the inner cladding element 516.

It is also preferred that one or more heating elements 530 are positioned to heat the outer cladding element 517 in a non-oxidizing atmosphere to a hot working temperature. Once the outer cladding element 517 is at the hot working temperature, the heating element 530 is removed, and the outer cladding element 517 is formed by forming devices 552 (FIG. 5D).

In another alternative embodiment, illustrated in FIGS. 5E and 5F, inner cladding elements 616A, 616B preferably are secured to each of the body portion 668 and the tube portion 666 of the vessel 664, which is made of a base element 622. An outer cladding element 617 is positioned to cover parts 676A, 676B of the inner cladding elements 616A, 616B respectively (FIG. 5E). One or more heating elements 630 are provided, and positioned to heat the outer cladding element 617 in a non-oxidizing atmosphere, to a hot working temperature.

Once the outer cladding element 617 has been heated to a hot working temperature, the heating element 630 is removed, and the outer cladding element 617 is engaged against the parts 676A, 676B of the inner cladding elements 616A, 616B, by the forming device 652. The forming device is moved in the direction indicated by arrow “3Y” to engage the outer cladding element 617, to form the cladding element 617 as required.

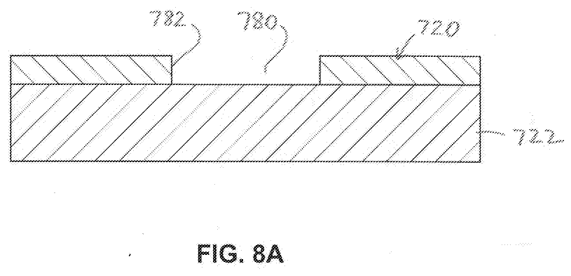

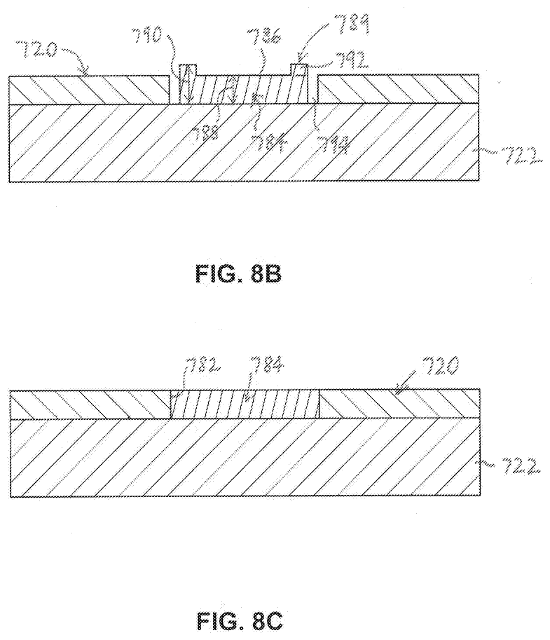

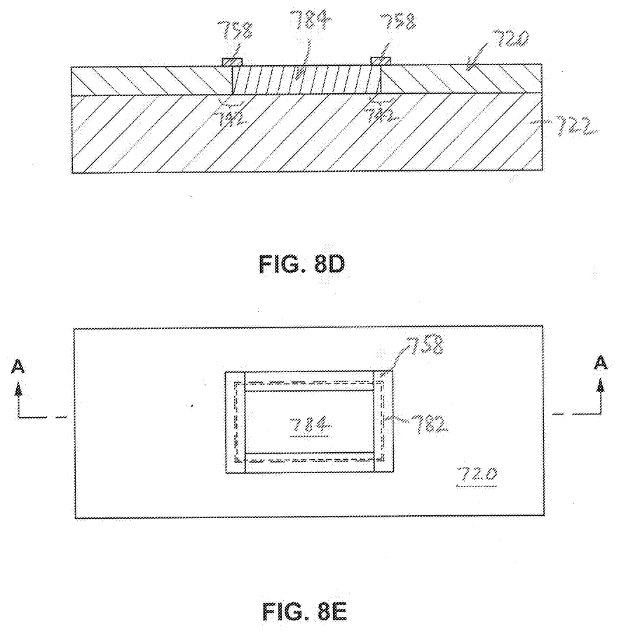

Those skilled in the art would appreciate that the cladding element may develop cracks or openings over time. In one embodiment, the invention includes a method of filling an opening 780 in a cladding element 720 that is secured to a base element 722 (FIG. 8A). As can be seen in FIG. 8A, the opening 780 is defined by one or more sides 782 of the cladding element 720.

Preferably, the method includes providing a patch cladding element 784 having a central region 786 with a central region thickness 788, and an outer region 789 with an outer region thickness 790 that is greater than the central region thickness 788 (FIG. 8B). An outer region projection 792 represents the difference between the outer region thickness 790 and the central region thickness 788.

It will be understood that the opening 780 may have any configuration. As illustrated in FIG. 8A, the opening 780 is partially defined by the base element 722. However, those skilled in the art would appreciate that the opening 780 may not necessarily be partially defined by the base element 722.

The patch cladding element 784 preferably is secured in the opening 780 using any suitable method. For example, a first heating element (not shown) may be used to heat the patch cladding element 784 and the base element 722 to a hot working temperature, and the patch cladding element 784 and the base element 722 may be secured together thereafter, as described above. Once the patch cladding element 784 is located in the opening 780, the patch cladding element 784 defines one or more troughs 794 between the patch cladding element 784 and the side(s) 782 of the cladding element 720 (FIG. 8B).

It will be understood that the first heating element used to heat the patch cladding element 784 before it is secured to the base element 722 is not shown in order to simplify the drawings.

Next, with a second heating element (not shown), the outer region 789 preferably is heated to a hot working temperature, in a non-oxidizing atmosphere. Once the outer region 789 is heated to the hot working temperature, with one or more forming devices (not shown), the outer region projection 792 is pushed into the trough 794.

Subsequently, the patch cladding element 784 is permitted to cool to a predetermined temperature, for recrystallization of the outer region projection 792 in the trough 794, for bonding the outer region projection with the base element 722 and the cladding element 720. The result is illustrated in FIG. 8C, in which the patch cladding element 784 fills (or substantially fills) the opening 780.

As can be seen in FIG. 8C, after the outer region projection 792 has been positioned in the trough 794, a boundary region 742 is defined where the material of the patch cladding element 784 (i.e., the outer region projection material) engages the side 782 of the cladding element 720. In another alternative embodiment of the invention, the method includes providing an additional cladding element 758 positionable on the boundary region 742, so that the additional cladding element 758 is bonded with each of the patch cladding element 784 and the cladding element 720.

It will be understood that the additional cladding element 758 preferably is heated with a heating element (not shown) to a hot working temperature, and then while the additional cladding element 758 is at the hot working temperature, the additional cladding element 758 is engaged with each of the patch cladding element 784 and the cladding element 720 by forming devices, to bond the additional cladding element 758 with each of the patch cladding element 784 and the cladding element 720. The heating element and the forming devices are omitted from FIGS. 8C and 8D for clarity of illustration.

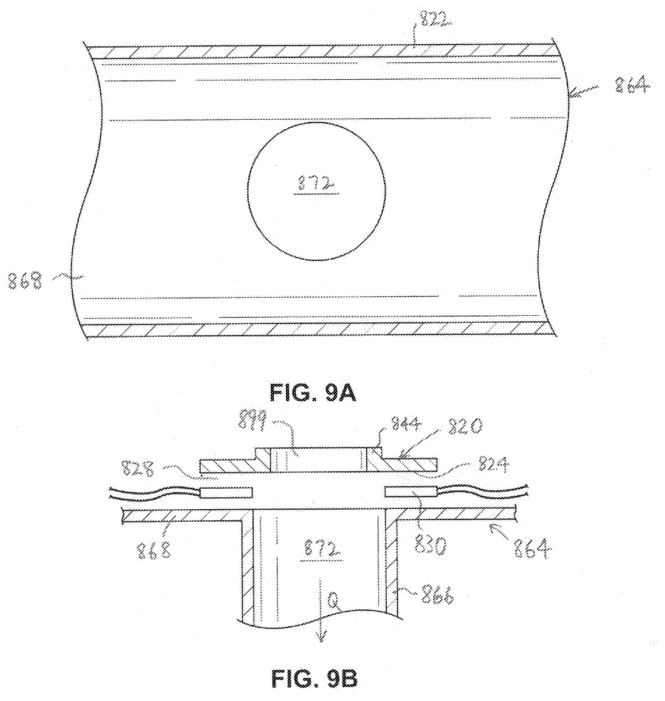

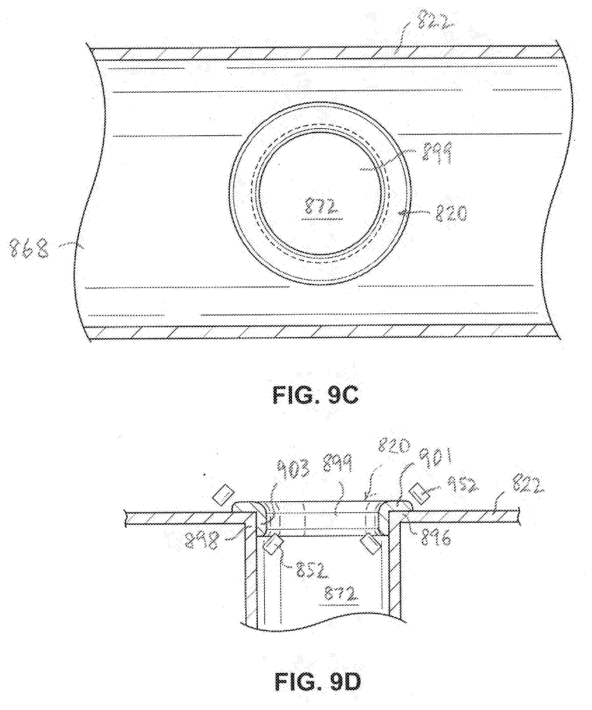

In another embodiment, the invention provides a method of covering a base element 822 that forms a vessel 864 including a tube portion 866 and a body portion 868 defining a chamber 870 therein. As can be seen in FIG. 9A, the tube portion 866 defines a channel 872 therein in fluid communication with the chamber 870, to permit flow through the tube portion 866 in a predetermined downstream direction indicated by arrow “Q” in FIG. 9B. Preferably, the method includes providing a cladding element 820 formed for engagement with a first selected part 896 of the body portion 868, and a second selected part 898 of the tube portion 866 (FIG. 9D).

As can be seen in FIGS. 9B and 9C, it is preferred that the cladding element 820 is formed to define an aperture 899 therein. In one embodiment, the cladding element 820 preferably includes a thick region 844 located proximal to the aperture 899.

It is preferred that the cladding element 820 is positioned spaced apart from the body portion 868 to define a slot 828 between an inner side 824 of the cladding element 820 and the body portion 868 (FIG. 9B). Next, as can be seen in FIG. 9B, one or more heating elements 830 is located in the slot 828. A non-oxidizing atmosphere is provided in the slot 828. The non-oxidizing atmosphere covers the inner side 824 and the first and second selected parts 896, 898.

The heating element 830 is energized, to heat the inner side 824 and the first and second selected parts 896, 898 to a hot working temperature. Next, the heating element 830 is removed from the slot 828.

While the inner side 824 and the first and second preselected parts 896, 898 are at the hot working temperature, a first segment 901 of the inner side 824 is engaged with the first preselected part 896, pressed by a forming device 852 (FIG. 9D). Also, with a forming device 952, a second segment 903 of the inner side 824 is engaged with the second preselected part 898.

While the inner side 824 is engaged with the first and second preselected parts 896, 898, the first segment 901 and the first preselected part 896 are pressed together, and the second segment 903 and the second preselected part 898 are pressed together, to plastically deform the first segment 901 and the first part 896, and to plastically deform the second segment 903 and the second part 898, to subject the first segment 901 and the first part 896 to shear stresses, and also to subject the second segment 903 and the second part 898 to shear stresses, to provide at least partially uniformity of the microstructures of the inner side 824 and the first and second parts 896, 898, as described above. Those skilled in the art would appreciate that the thick region 844 may be required in order to provide sufficient material to form the first and second segments 901, 903.

Preferably, the inner side 824 and the first and second preselected parts 896, 898 are permitted to cool to a predetermined temperature, for recrystallization of the inner side 824 and the first and second preselected parts 896, 898 that are thereby bonded with each other.

It will be understood that the cladding element 820 preferably is formed to fit over the tube portion 866, so that the aperture 899 registers with the channel 872, i.e., they are coaxial once the cladding element 820 has been bonded in place. Those skilled in the art would appreciate that the cladding element 820 may be sized and configured for use with a wide variety of vessels that include tube portions connected with body portions thereof.

Those skilled in the art would appreciate that, when two pipes 905A, 905B made of a base element 922 are joined, there may be an opening or a crack (not shown) in a boundary region 942 at the respective ends 907A, 907B of the pipes 905A, 905B, where they are joined together. In one embodiment, the invention includes a method of covering the boundary region 942 defined by the two pipes 905A, 905B abutting each other at their respective ends 907A, 907B, the boundary region 942 being defined by the abutted respective ends 907A, 907B. Preferably, the method includes providing one or more cladding elements 920A, 920B, and locating the cladding elements 920A, 920B proximal to the boundary region 942.

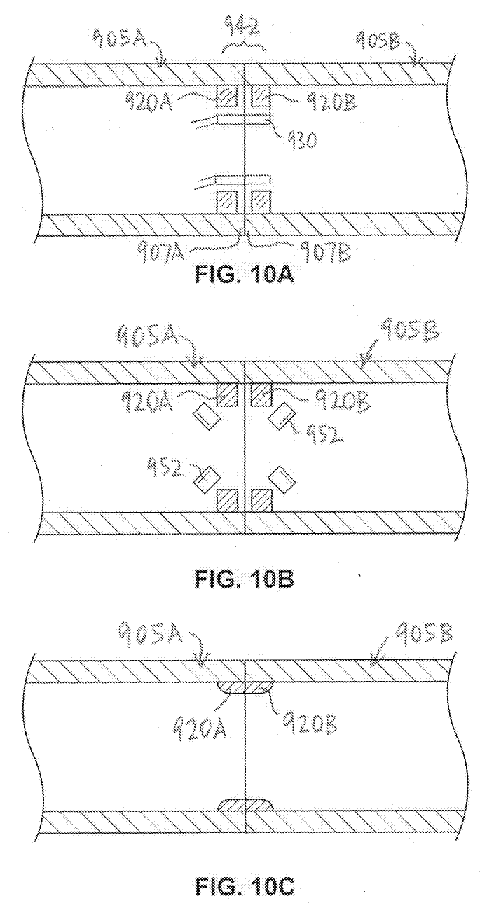

In FIGS. 10A and 10B, two cladding elements are illustrated, identified by reference characters 920A, 920B. However, it will be understood that only one cladding element may be utilized.

As can be seen in FIG. 10A, one or more heating elements 930 preferably are located proximal to the cladding elements 920A, 920B. A non-oxidizing atmosphere covering the cladding elements 920A, 920B is provided.

The heating element 930 is energized, to heat the cladding elements 920A, 920B to a hot working temperature. The heating element 930 is then removed.

With one or more forming devices 952, while the cladding elements 920A, 920B are at the hot working temperature, the cladding elements 920A, 920B preferably are plastically deformed, to cover the boundary region 942, for bonding the cladding elements 920A, 920B with the base element 922. The cladding elements 920A, 920B are permitted to cool to a predetermined temperature.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

I claim:

1. A method of attaching at least one cladding element at least partially made of a first metal to a base element at least partially made of a second metal, the method comprising the steps of:
(a) positioning said at least one cladding element spaced apart from the base element to locate a first inner side of said at least one cladding element facing a second inner side of the base element, for defining a slot therebetween having a predetermined width;
(b) locating at least one heating element in the slot;
(c) providing a non-oxidizing atmosphere in the slot, the non-oxidizing atmosphere covering the first and second inner sides;
(d) energizing said at least one heating element, to heat the first inner side and the second inner side to a hot working temperature of the first metal and the second metal, wherein said at least one heating element is configured to distribute heat energy therefrom evenly over each of the first and second inner sides, heating the cladding element and the base element to predetermined first and second depths relative to the first and second inner sides respectively, to provide heated first and second layers of the cladding element and the base element respectively;
(e) removing said at least one heating element from the slot;
(f) while the first and second layers are at the hot working temperature, engaging the first and second inner sides with each other;
(g) while the first and second inner sides are engaged with each other, moving at least part of one of said at least one cladding element and the base element relative to the other of said at least one cladding element and the base element, to at least partially plastically deform the first and second layers to subject the first and second layers to shear stresses; and
(h) permitting the first and second layers to cool to a predetermined temperature, for recrystallization of the first and second layers, that are thereby bonded to each other.

2. A method according to claim 1 in which at least one of the first inner side and the second inner side is scored, for engagement of the first and second inner sides with each other.

3. A method according to claim 1 in which, in step (f), one or both of said at least one cladding element and the base element are moved in a preselected direction that is orthogonal to the first and second inner sides, and in step (g), the movement of said at least part of one of said at least one cladding element and the base element is transverse to the preselected orthogonal direction.

4. A method according to claim 1 in which, in step (f), one or both of said at least one cladding element and the base element are moved in a preselected direction that is orthogonal to the first and second inner sides, and in step (g), the movement of said part of said at least one of said at least one cladding element and the base element is effected by percussively engaging said part of said at least one of said at least one cladding element and the base element in a direction parallel to the preselected orthogonal direction.

5. A method of attaching at least one cladding element at least partially made of a first metal and a base element at least partially made of a second metal together, the method comprising the steps of:
(a) positioning said at least one cladding element spaced apart from the base element to locate a first inner side of said at least one cladding element facing a second inner side of the base element, for defining a slot therebetween having a predetermined width;
(b) locating at least one heating element in the slot;
(c) providing a non-oxidizing atmosphere in the slot, the non-oxidizing atmosphere covering the first and second inner sides;
(d) energizing said at least one heating element, to heat the first inner side and the second inner side to a hot working temperature of the first metal and the second metal, wherein said at least one heating element is configured to distribute heat energy therefrom evenly over each of the first and second inner sides, heating the cladding element and the base element to predetermined first and second depths relative to the first and second inner sides respectively, to provide heated first and second layers of the cladding element and the base element respectively;
(e) removing said at least one heating element from the slot;
(f) while the first and second layers are at the hot working temperature, engaging the first and second inner sides with each other;
(g) while the first and second inner sides are engaged with each other, pressing at least part of one of said at least one cladding element and the base element against the other of said at least one cladding element and the base element, to at least partially plastically deform the first and second layers to subject the first and second layers to shear stresses; and
(h) permitting the first and second layers to cool to a predetermined temperature, for recrystallization of the first and second metals in the respective first and second layers, that are thereby bonded to each other.

6. A method of attaching at least one cladding assembly at least partially made of a cladding element and a first metal element comprising a first metal, and a base element at least partially made of a second metal, the method comprising the steps of:
(a) securing the cladding element and the first metal element together, to form said at least one cladding assembly;
(b) positioning said at least one cladding assembly spaced apart from the base element to locate a first inner side of said at least one cladding assembly facing a second inner side of the base element, for defining a slot therebetween having a predetermined width, the first inner side of said at least one cladding assembly being formed to adhere to the second inner side;
(c) locating at least one heating element in the slot;
(d) providing a non-oxidizing atmosphere in the slot, the non-oxidizing atmosphere covering the first inner side and the second inner side;
(e) energizing said at least one heating element, to heat the first inner side and the second inner side to a hot working temperature of the first metal and the second metal, wherein the heating element is configured to distribute heat energy therefrom evenly over each of the first and second inner sides, heating the first metal element and the base element to predetermined first and second depths relative to the first and second inner sides respectively, to provide heated first and second layers of the first metal element and the base element respectively;
(f) removing said at least one heating element from the slot;
(g) while the first and second layers are at the hot working temperature, engaging the first and second inner sides with each other;
(h) while the first and second inner sides are engaged with each other, moving at least part of one of the first metal element and the base element relative to the other of the first metal element and the base element, to at least partially plastically deform the first and second layers, subjecting the first and second layers to shear stresses; and
(i) permitting the first and second layers to cool to a predetermined temperature, for recrystallization of the first and second metals in the respective first and second layers, that are thereby bonded to each other.

7. A method according to claim 6 in which at least one of the first inner side and the second inner side is scored, for engagement of the first and second inner sides with each other.

8. A method according to claim 1 in which:
said at least one cladding element comprises first and second cladding elements, each said first and second cladding element having an edge, the edges of the first and second cladding elements located proximal to each other after the first and second cladding elements are attached with the base element, said edges defining an opening therebetween, each said first and second cladding element comprising a thick region extending along the edge thereof respectively, each of the thick regions being thicker than the balance of the respective first and second cladding elements;
at least one supplemental heating element is positioned proximal to the thick regions of the first and second cladding elements;
said at least one supplemental heating element is energized, to heat the thick regions of the first and second cladding elements to a thick region hot working temperature, in a non-oxidizing atmosphere; and
with at least one forming device, the thick regions are plastically deformed, to fill the opening.

9. A method according to claim 8 in which the thick regions are overlain by an additional cladding element that is secured to the thick regions.

10. A method according to claim 1 in which:
said at least one cladding element comprises first and second cladding elements, each said first and second cladding elements comprising an edge, the edges of the first and second cladding elements being located proximal to each other after the first and second cladding elements are attached to the base element to define a boundary region therebetween;
at least one additional cladding element is located spaced apart from the first and second cladding elements proximal to the edges thereof to define an additional element gap between said at least one additional cladding element and the first and second cladding elements;
at least one heating element is positioned between said at least one additional cladding element and the first and second cladding elements;
said at least one heating element is energized in a non-oxidizing atmosphere, to heat said at least one additional cladding element and the first and second cladding elements to an additional cladding element hot working temperature;
while said at least one additional cladding element and the first and second cladding elements are at the additional cladding element hot working temperature, engaging said at least one additional cladding element with the first and second cladding elements at the edges thereof wherein said at least one additional cladding element covers the boundary region;
while said at least one additional cladding element is engaged with the first and second cladding elements, moving at least part of said at least one additional cladding element relative to the first and second cladding elements, to plastically deform said at least one additional cladding element and at least a portion of the first and second cladding elements; and
permitting said at least one additional cladding element and the first and second cladding elements to cool to the predetermined temperature, for recrystallization of said at least one additional cladding element and the first and second cladding elements, wherein said at least one additional cladding element is thereby bonded to the first and second cladding elements and said at least one additional cladding element fills the opening.
